(19) United States
(12) Patent Application Publication
(10) Pub. No.: US 2025/0037112 A1
(43) Pub. Date: Jan. 30, 2025

(54) DECENTRALIZED IDENTIFIER BASED FORM SUBMISSIONS

(71) Applicant: American Express Travel Related Services Company, Inc., New York, NY (US)

(72) Inventors: Ajay Babu Maddukuri, Phoenix, AZ (US); Emery Schoenly, Salisbury, CT (US)

(21) Appl. No.: 18/361,155

(22) Filed: Jul. 28, 2023

(51) Int. Cl. G06Q 20/36; G06F 40/174; G06Q 20/40

(52) U.S. Cl. CPC G06Q 20/363; G06F 40/174; G06Q 20/40

(57) ABSTRACT

Disclosed are various embodiments for complete webforms based on decentralized identifiers. A decentralized identifier communication (DIDComm) protocol connection is established with a wallet application. Then, a request is sent to the wallet application for a verifiable credential (VC) that contains at least one value for at least one field in a web application. The VC is then received from the wallet application and verified or validated. Next, at least one field in a form is completed with the at least one value specified by the verifiable credential. The web application is then updated to reflect that the at least one field has been filled with the at least one value.

### BACKGROUND

Users often fill out forms on websites or web pages. For example, a user may be required to provide their legal name, mailing address, and other personal information when attempting to purchase or procure good or services, enter into an agreement, etc. Moreover, recipients of this information may desire or be required to verify the accuracy of the information entered to make sure it is not fraudulent or inaccurate.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1A-F are pictorial diagram of an example user interfaces according to various embodiments of the present disclosure.

FIG. 2 is a drawing of a network environment according to various embodiments of the present disclosure.

FIG. 3 is a sequence diagram illustrating one example of interactions between applications executed in a computing environment in the network environment of FIG. 2 according to various embodiments of the present disclosure.

FIG. 4 is a sequence diagram illustrating one example of interactions between applications executed in a computing environment in the network environment of FIG. 2 according to various embodiments of the present disclosure.

### DETAILED DESCRIPTION

Disclosed are various approaches for completing and submitting forms for a web page or a web application using decentralized identifiers (DIDs) and associated verifiable credentials (VCs). A user can select a DID that has one or more verifiable credentials associated with it to be used to complete a form for a web page or web application. In some implementations, the user can also select a verifiable credential to be shared with the web page or web application. In other implementations, the web page or web application can then select one or more verifiable credentials (VCs) and request that they be shared. However, in other implementations, the web page or web application could identify and/or request that a specific DID and/or VC associated with the user be used for completing the form. In these implementations, the user could review the request and grant or deny permission for the web page or web application to use the requested DID and/or VC.

In any of these implementations, the web page or web application can verify the validity and/or integrity of the VC. If the VC is valid, the web page or web application can use the values of attributes represented by the VC to complete the form. The user can then review and submit the form. Upon submission, the web page or web application can verify that the values submitted by the user match the values included in the VC. As a result, a user is able to automatically and accurately complete web forms, while the host of the web page or web application can rely on the cryptographic assurances provided by the DID and the VC to ensure the accurate and valid information is used to complete the form.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

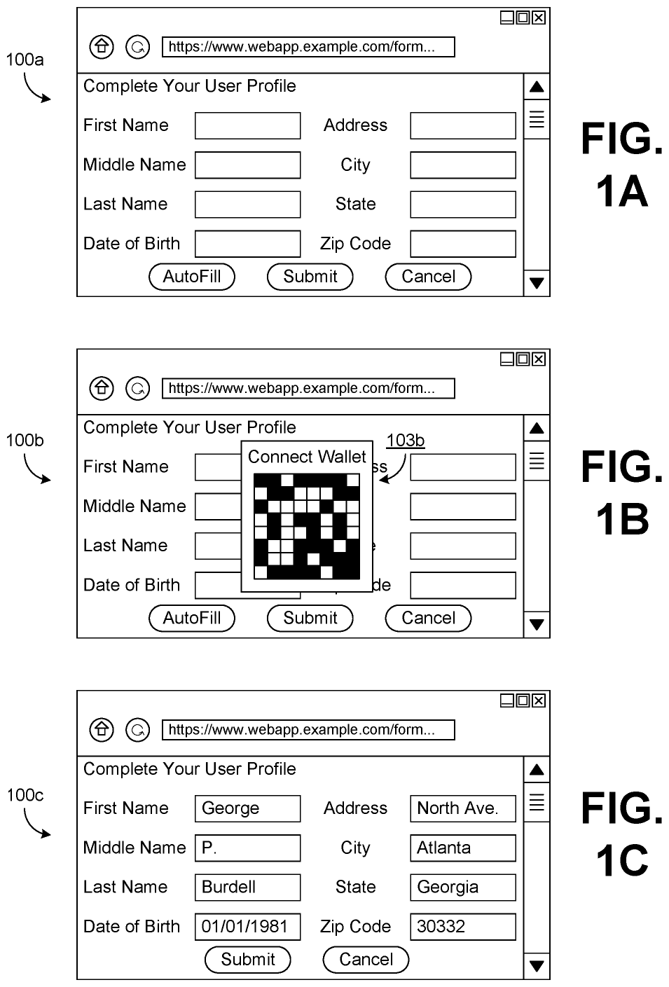

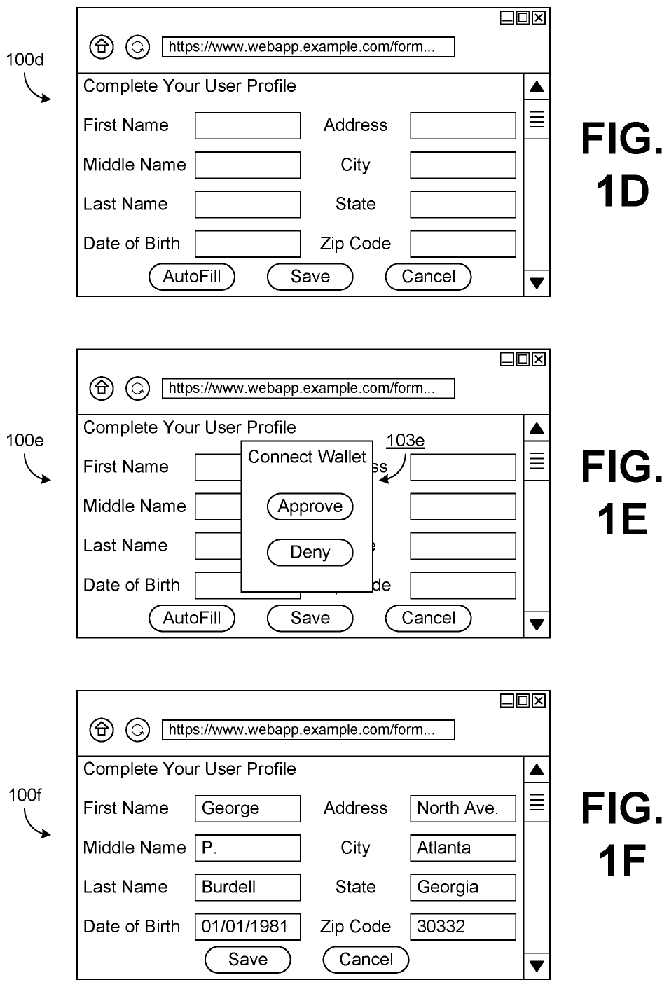

FIGS. 1A-C depict a sequence of user interface diagrams for user interfaces 100a-c (collectively the “user interfaces 100” and generically a “user interface 100”), respectively. The user interfaces 100 depict one example of a user experience with various embodiments of the present disclosure. Other user interfaces 100 and other user experiences are also encompassed by the various embodiments of the present disclosure.

For example, a user could be presented with a form to complete within a user interface 100 of a client application, such as a web browser. The user interface 100a depicts an example of a form within a browser. The form can include various fields related to the personal identity of the user and provides the user with the option to manually complete the form by typing in values or to select an option to automatically fill or complete the fields.

If the user were to select the “autofill” option, then the user could be presented with prompt 103b to allow his or her wallet application to establish a connection with the web page or web application (e.g., via the Decentralized Identifier Communication (DIDComm) protocol), as depicted in FIG. 1B. The prompt 103b could include the information necessary to establish the connection, such as a matrix bar code (e.g., a quick response (QR) code) the encodes information necessary for a wallet application to establish the connection. If the user were to scan the matrix bar code with a mobile device (e.g., smart phone, tablet, etc.) that had the wallet application installed, then the wallet application could use the information encoded within the matrix bar code to establish the connection with the web page or web application.

Once the connection is made, the user interface 100 could be refreshed by the browser to include an updated view or version of the web page or web application, as depicted by the user interface 100c of FIG. 1C. Here, the fields of the form would include information associated with the VC of the DID of the user. The user would have the option, in some implementations, to review and verify the information for accuracy or completeness before submitting the form.

FIGS. 1D-F depict another sequence of user interface diagrams for user interfaces 100d-f (collectively the “user interfaces 100” and generically a “user interface 100”), respectively. The user interfaces 100 depict one example of a user experience with various embodiments of the present disclosure. Other user interfaces 100 and other user experiences are also encompassed by the various embodiments of the present disclosure.

For example, a user could be presented with a form to complete within a user interface 100 of a client application, such as a web browser. The user interface 100d depicts an example of a form within a browser. The form can include various fields related to the personal identity of the user and provides the user with the option to manually complete the form by typing in values or to select an option to automatically fill or complete the fields.

If the user were to select the “autofill” option, then the user could be presented with prompt 103e to allow his or her wallet application to establish a connection with the web page or web application (e.g., via the Decentralized Identifier Communication (DIDComm) protocol). The prompt 103e could include a request that the user allow or deny the connection, which could be established in the background between the wallet application and the web page or web application if the user were to approve the connection request.

Once the connection is made, the user interface 100 could be refreshed by the browser to include an updated view or version of the web page or web application, as depicted by the user interface 100f of FIG. 1F. Here, the fields of the form would include information associated with the VC of the DID of the user. The user would have the option, in some implementations, to review and verify the information for accuracy or completeness before submitting the form.

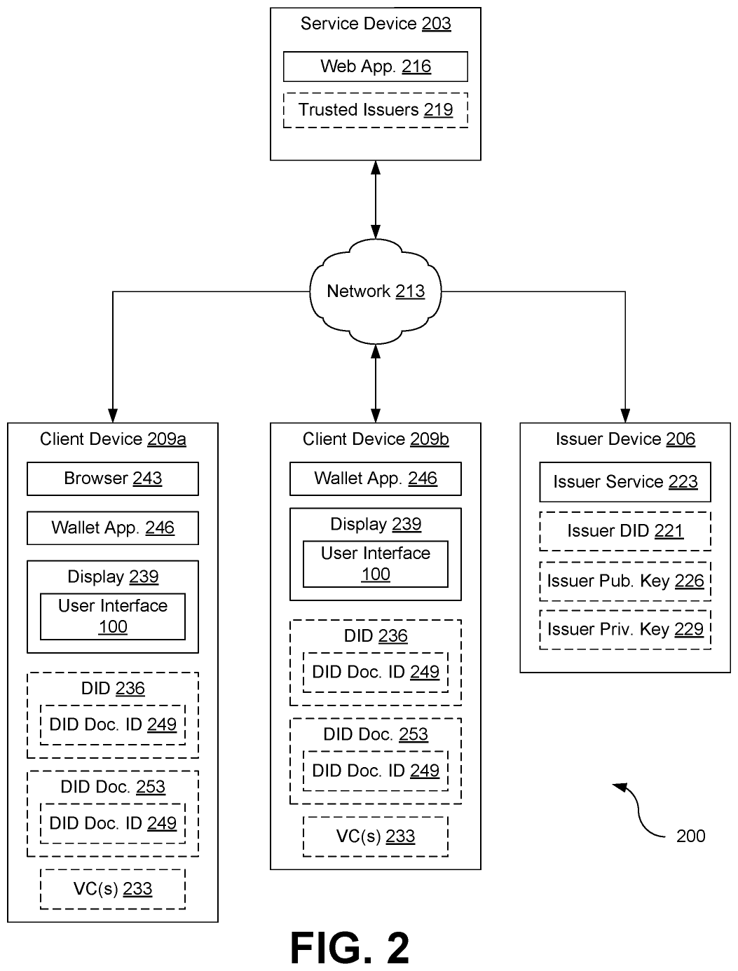

With reference to FIG. 2, shown is a network environment 200 according to various embodiments. The network environment 200 can include one or more computing devices that include a processor, a memory, and/or a network interface. These computing devices can include a service device 203, an issuer device 206, one or more client devices 209 (e.g., client device 209a and client device 209b), and potentially other computing devices.

One or more of these computing devices could be located within a computing environment. Such a computing environment could employ a plurality of computing devices that can be arranged in one or more server banks or computer banks or other arrangements. Such computing devices can be located in a single installation or can be distributed among many different geographical locations. For example, the computing environment can include a plurality of computing devices that together can include a hosted computing resource, a grid computing resource or any other distributed computing arrangement. In some cases, the computing environment can correspond to an elastic computing resource where the allotted capacity of processing, network, storage, or other computing-related resources can vary over time.

These computing devices can be in data communication with each other via a network 213. The network 213 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 213 can also include a combination of two or more networks 213. Examples of networks 213 can include the Internet, intranets, extranets, virtual private networks (VPNs), and similar networks.

A service device 203 can represent one or more computing devices that host web sites, web pages, and/or web applications. Accordingly, a service device 203 could be configured to host or provide a web application 216, as well any ancillary services or programs required to host or provide the web application 216, such as web servers or services, database servers or services, etc. A service device 203 could also store a list of one or more trusted issuers 219, according to various embodiments of the present disclosure.

A web application 216 can include any software application accessible using a web browser or similar software. A web application could include, for example, a set of web pages that, when accessed by a user, allow a user to view or submit different types of data or perform different actions or operations. Some of the web pages provided by the web application to the browser on the user's device could include embedded scripts that could be executed to provided enriched client-side functionality and/or communicate with the web application on the service device 203 asynchronously.

The trusted issuers 219 can represent a list of one or more issuer devices 206 or issuer services 223 that are trusted by the web application 216. For example, a service device 203 or web application 216 could be configured to only trust verifiable credentials 233 issued by particular issuers who are known to be trustworthy. For example, a trusted issuer of verifiable credentials 233 might be trusted to determine the veracity of any information included in a verifiable credential 233 that it issues. Therefore, the service device 203 or web application 216 could be configured to only or preferentially rely on verifiable credentials issued by issuer devices 206 or issuer services 223 listed in the trusted issuers 219.

Issuer devices 206 or issuer services 223 could be identified among the trusted issuers 219 in a variety of manners. For example, the issuer public key 226, or a fingerprint of the issuer public key 226, associated with an issuer service 223 or issuer device 206 could be used as an identifier for a trusted issuer 219. As another example, a unique identifier for the operator of the issuer device 206 or issuer service 223 could be used as an identifier for a trusted issuer 219. An example of such a unique identifier would be an issuer decentralized identifier (DID) 221 or a fingerprint of an issuer public key 226. The issuer DID 221 can be implemented using various standards, such as a version of the World Wide Web Consortium's (W3C's) Decentralized Identifier (DID) standard.

An issuer device 206 can represent one or more computing devices that are used to issue verifiable credentials 233. An issuer device 206 could be configured to host or execute an issuer service 223. An issuer device 206 could also store or have access to an issuer public key 226 and/or an issuer private key 229. The issuer device 206 and/or issuer service 223 could be operated by a variety of entities, including government agencies and corporate entities. For example, government agencies that are responsible for issuing government identification documents (e.g., driver's licenses, passports, etc.) could operate issuer devices 206 and/or issuer services 223 in order to issue verifiable credentials 233 to individuals. As another example, corporations that have extensive, verified knowledge about the identity of customers or individuals (e.g., data brokers, identity brokers, financial institutions, etc.) could operate issuer devices 206 and/or issuer services 223 in order to issue verifiable credentials 233 to individuals.

The issuer service 223 could be executed to respond to requests to issue verifiable credentials 233. For example, an issuer service 223 could receive a request to issue a verifiable credential from a client device 209. The request could include a specific decentralized identifier (DID) 236 for the verifiable credential 233 to be associated with and/or information identifying the user or individual associated with the DID 236. The issuer service 223 could then issue a verifiable credential 233 in response, which could be signed by the issuer private key 229 to allow third parties to determine the authenticity of the verifiable credential 233.

The issuer public key 226 and the issuer private key 229 could be parts of a public-private or asymmetric cryptographic key-pair used by the issuer service 223 when issuing verifiable credentials 233. The issuer private key 229 could be used to sign any verifiable credentials 233 issued, allowing third parties to determine the authenticity of the verifiable credential 233. The issuer public key 226 could be provided to any third party that requested the issuer public key 226 in order to verify that a verifiable credential 233 signed by the issuer private key 229 is genuine. The issuer public key 226, or a fingerprint of the issuer public key 226 could also be used to uniquely identify an issuer device 206 or issuer service 223 with respect to other issuer devices 206 or issuer services 223.

A client device 209 is representative of one or more client devices 209 that can be coupled to the network 213, such as client device 209a and client device 209b (collectively the “client devices 209” and generically a “client device 209”). A client device 209 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. A client device 209 can include one or more displays 239, such as liquid crystal displays (LCDs), gas plasma-based flat panel displays, organic light emitting diode (OLED) displays, electrophoretic ink (“E-ink”) displays, projectors, or other types of display devices. In some instances, the display 239 can be a component of a client device 209 or can be connected to a client device 209 through a wired or wireless connection.

A client device 209 can be configured to execute various applications such a browser 243, a wallet application 246, or other applications. The browser 243 can be used to access and/or interact with web pages or websites, such as those provided by or used when interacting with a web application 216. Examples of browsers 243 include GOOGLE CHROME®, APPLE SAFARI®, MICROSOFT EDGE®, and MOZILLA FIREFOX®. The wallet application 246 can represent any application that allows a user to manage his or her digital identity, including generating or issuing DIDs 236; creating and/or storing DID Documents 249; requesting, obtaining, or sharing verifiable credentials 233; revoking or invalidating DIDs 236 or verifiable credentials 233; etc. The wallet application 246 could be a separate, standalone application or, in some implementations, could be an extension or plugin this is run by the browser 243.

A decentralized identifier (DID) 236 can correspond to an identifier that enables a verifiable, decentralized digital identity for a subject (e.g., a person, organization, thing, etc.). For example, a DID 236 can be used to represent the identity of a user, a computing device, or other objects. An individual can have multiple DIDs 236. For example, a user might use a first decentralized identifier 236 to manage their work-related identity and a second decentralized identifier 236 to manage their personal identity outside of work. Each DID 236 can include one or more DID document identifiers 249. A DID document identifier 249 can include any identifier that uniquely identifies a DID document 253 with respect to another DID document 253. In some implementations, the DID 236 can be implemented using various standards, such as a version of the World Wide Web Consortium's (W3C's) Decentralized Identifier (DID) standard.

A DID document 253 is a document which describes how to interact with the owner of the DID 236. For example, the DID document 253 can describe the mechanisms by which a subject of a DID 236 can authenticate itself or prove its association with the DID 236. This can include identifying the cryptographic public keys corresponding to the cryptographic private keys held by the subject of a DID 236. In some implementations, the DID document 253 can be implemented using various standards, such as a version of the W3C's Decentralized Identifier (DID) standard.

A verifiable credential 233 represents a credential issued by an issuer service 223 to the wallet application 246 of the user, which can store the verifiable credential 233 on the client device 209. Verifiable credentials 233 can be represented, for example, using JavaScript Object Notation (JSON) objects or files. A verifiable credential 233 can include various fields or data, such as the issuer of the verifiable credential 233, the subject of the verifiable credential 233, the type of credential, etc. Fields such as those representing the issuer or subject of the verifiable credential 233 could have a respective DID 236 specified as the identifier of the issuer or subject. For example, a first DID 236 could be included in the verifiable credential 233 to identify the user of the client device 209 and a second DID 236 could be included in the verifiable credential 233 that identifies the issuer device 206 or issuer service 223 that issued the verifiable credential 233. In some implementations, verifiable credentials 233 could be implemented using a standard, such as a version of the W3C's “Verifiable Credentials Data Model.”

It should be noted that although the DIDs 233 and DID documents 253 illustrated are stored locally on client devices 209, DIDs 233 and/or DID documents 253 could be stored in publicly available databases or ledgers, such as decentralized distributed ledgers (e.g., public blockchains such as ETHEREUM®. However, DIDs 233 and DID documents 253 can be stored locally on client devices 209 to allow for additional privacy for the user.

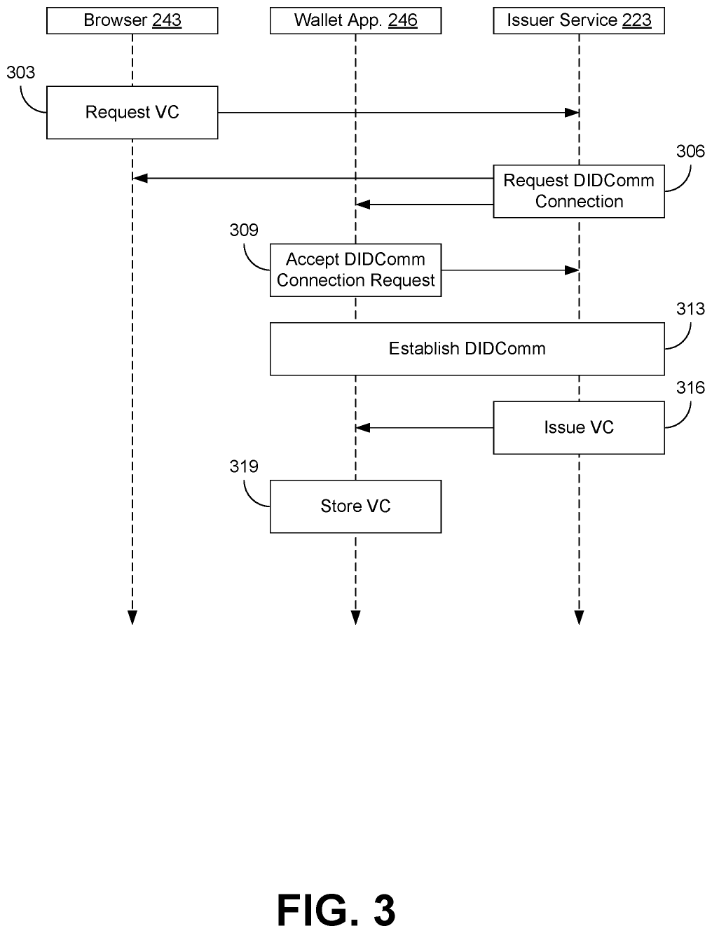

Referring next to FIG. 3, shown is a sequence diagram that provides one example of the interactions between the browser 243, wallet application 246, and issuer service 223. The sequence diagram of FIG. 3 provides merely an example of the many different types of interactions between the browser 243, wallet application 246, and issuer service 223. As an alternative, the sequence diagram of FIG. 3 can be viewed as depicting an example of elements of a method implemented within the network environment 200.

Beginning with block 303, a user of a client device could use the browser 243 to send a request for a verifiable credential 233 to the issuer service 223. For example, the issuer service 223 could provide a web-based portal where a user could provide personally identifying information to the issuer service 223 to be used for a verifiable credential. As another example, the issuer service 223 could provide a web-based portal where a user could authenticate himself or herself in order to request that a verifiable credential 233 be issued on his or her behalf based at least in part on information know or available to the issuer service 223.

In response, at block 306, the issuer service 223 could make a request to establish a DIDcomm connection with the wallet application 246 of the user. For example, the issuer service 223 could send a matrix bar code (e.g., a quick response (QR) code) to the browser 243, which the browser could show on a display of a client device 209. As another example, the issuer service 223 could send a connection message or request to the browser 243, which could then relay or pass on the message to a wallet application 246 executed by the client device 209. In response, the wallet application 246 could display a prompt, or cause the browser 243 to display a prompt, such as prompt 103e, to obtain the approval of the user to establish the connection between the wallet application 246 and the issuer service 223.

At block 309, the user could use his or her wallet application 246 to accept the DIDcomm connection request. For example, the user could use his or her wallet application on a second client device 209 to scan the matrix bar code shown on the display of the client device 209 that is executing the browser 243 in order to accept the DIDComm request. As another example, the user could approve the connection request using a prompt shown by the wallet application 246 or the browser 243. Other approaches for accepting or approving a DIDcomm connection between the issuer service 223 and the wallet application 246 according to various embodiments of the present disclosure.

Proceeding to block 313, the wallet application 246 and the issuer service 223 can establish a DIDcomm connection in response to the user approving or consenting to the connection using the wallet application 246 at block 309. This can be accomplished according to the specification of any version of the DIDcomm protocol as published by the Decentralized Identity Foundation (DIF).

Moving to block 316, the issuer service 223 can create and issue a verifiable credential 233 for the user and provide the verifiable credential 233 to the wallet application 246. The verifiable credential 233 could be created to comply with a form or format specified by a version of the W3C's “Verifiable Credentials Data Model.” As part of the issuance process, the issuer service 223 could sign the verifiable credential 233 with the issuer private key 229 in order to allow third parties to confirm that the verifiable credential 233 was issued by the issuer service 223. The verifiable credential 233 could also include the issuer DID 221 associated with the issuer service 223, which could allow others to identify or otherwise determine which issuer service 223 issued an individual verifiable credential 233. The verifiable credential 233 could also include the DID 236 of the individual or entity identified by the verifiable credential 233.

Subsequently, at block 319, the wallet application 246 can store the verifiable credential 233 issued by the issuer service 223 on the client device 209. The wallet application 246 can, in some implementations, store the verifiable credential in a secure storage area (e.g., provided by a secure enclave of the client device) or in an encrypted form in order to prevent unauthorized use of the verifiable credential 233.

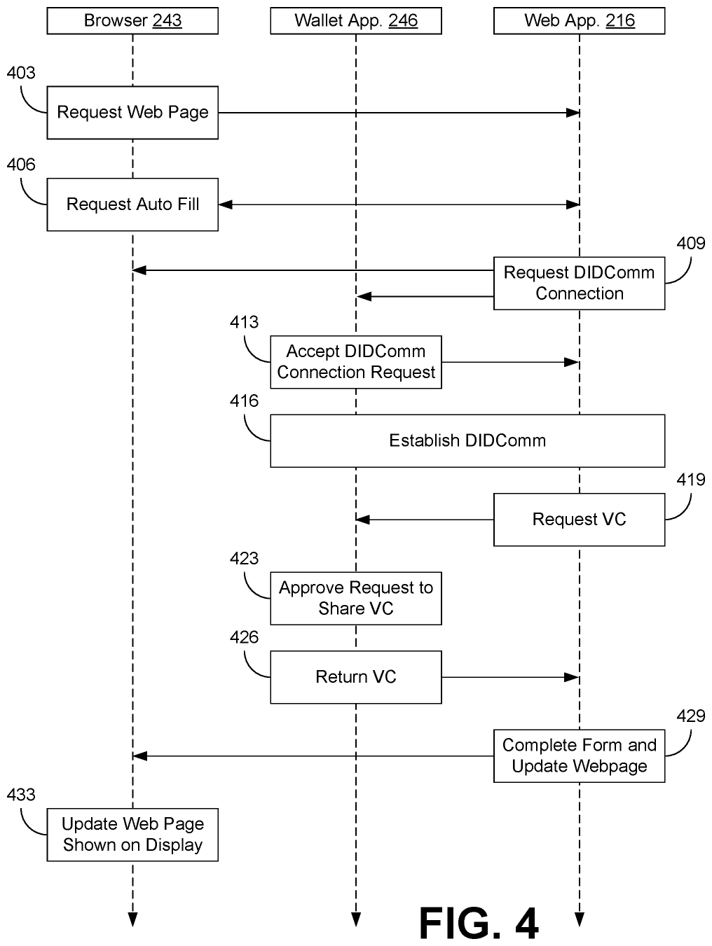

Referring next to FIG. 4, shown is a sequence diagram that provides one example of the interactions between the browser 243, wallet application 246, and web application 216. The sequence diagram of FIG. 4 provides merely an example of the many different types of interactions between the browser 243, wallet application 246, and web application 216. As an alternative, the sequence diagram of FIG. 4 can be viewed as depicting an example of elements of a method implemented within the network environment 200.

Beginning with block 403, the browser 243 can send a request for a webpage to the web application 216. In response to the request, the web application 216 can send the requested web page to the browser. As previously discussed, the web page could have one or more fields that require user input (e.g., a user form requiring the user to provide various types of personally identifying information).

Then, at block 406, the browser 243 can send a request to the web application 216 to automatically complete the fields in the web page (e.g., the fields of the form). For example, a user could select or interact with a user interface element of the web page (e.g., press a button with a mouse or press a button on a touch screen) to send a request to the web application 216 to automatically complete the form or fill in the fields on behalf of the user. The browser 243 would then send a notification or request to the web application 216 that the user would like for the fields of the web page to be automatically completed. As another example, the web application 215 could detect the presence of form fields in the web page. In these examples, the web application could send a prompt or message to the browser 243, which could be displayed by the browser 243 to the user. The prompt could ask the user whether he or she would like to have the web application 216 automatically complete the form or fill in the fields on behalf of the user. If the user approves of or consents to the request, then the browser 243 would then send a notification or request to the web application 216 that the user would like for the fields of the web page to be automatically completed.

Next, at block 409, the web application 216 can make a request to establish a DIDcomm connection with the wallet application 246 of the user. For example, the web application 216 could send a matrix bar code (e.g., a quick response (QR) code) to the browser 243, which the browser 243 could show on a display of a client device 209. As another example, the issuer service 223 could send a connection message or request to the browser 243, which could then relay or pass on the message to a wallet application 246 executed by the client device 209. In response, the wallet application 246 could display a prompt, or cause the browser 243 to display a prompt, such as prompt 103e, to obtain the approval of the user to establish the connection between the wallet application 246 and the issuer service 223.

Accordingly, at block 413, the user could use his or her wallet application 246 to accept the DIDcomm connection request. For example, the user could use his or her wallet application on a second client device 209 to scan the matrix bar code shown on the display of the client device 209 that is executing the browser 243 in order to accept the DIDComm request. As another example, the user could approve the connection request using a prompt (e.g., the prompt 103e) shown by the wallet application 246 or the browser 243. Other approaches for accepting or approving a DIDcomm connection between the issuer service 223 and the wallet application 246 according to various embodiments of the present disclosure.

Proceeding to block 416, the wallet application 246 and the web application 216 can establish a DIDcomm connection in response to the user approving or consenting to the connection using the wallet application 246 at block 413. This can be accomplished according to the specification of any version of the DIDcomm protocol as published by the Decentralized Identity Foundation (DIF).

Moving on to block 419, the web application 216 can request a verifiable credential 233 from the wallet application 246. This could be done using one or more of several approaches. In a first approach, the web application 216 could send a request for a verifiable credential 233 via the DIDcomm connection. This request could cause the wallet application 246 to prompt the user to select a verifiable credential 233 from one or more verifiable credentials 233 stored on the client device 209 of the user. In a second approach, the web application 216 could request a specific verifiable credential 233. This could be done, for example, by identifying the issuing entity of a specific verifiable credential 233. For instance, if the web application 216 and the issuer service 223 were operated by the same entity, the web application 216 could provide the issuer DID 221 of the issuer service 223 or issuer public key 226 of the issuer service 223 to the wallet application 246 as a mechanism for selecting a verifiable credential 233 that had been previously issued by the operator of the web application 216. This would allow the wallet application 246 to select a verifiable credential 233 issued by the issuer service 223 identified by the issuer DID 221 or issuer public key 226. In a similar example, the web application 216 could provide the set of issuer DIDs 221 or set of issuer public keys 226 included in the list of trusted issuers 219. This would act as a request for any verifiable credential 233 that had been issued by an issuer service 223 that was trusted by the web application 216.

Then, at block 423, the wallet application 246 could approve the request to share a verifiable credential 233 with the web application. For example, the user could select within the wallet application 246 a specific verifiable credential 233 that the user wished to share with the web application 216. As another example, the user could review one or more verifiable credentials 233 identified by the web application 216 and select which verifiable credential(s) 233 to share with the web application 216.

Next, at block 426, the wallet application 246 can return the verifiable credential(s) 233 selected and approved by the user. The verifiable credential(s) 233 could be returned using the same DIDcomm connection that was established at block 416.

Accordingly, at block 429, the web application 216 can complete the form or fill in the values for the fields using the information specified in the verifiable credential(s) 233 returned by the wallet application. Accordingly, the web application 216 could identify an attribute of the verifiable credential 233 that corresponds to at least one form field in the web page provided by the web application. This could be done, for example, by using pattern matching, regular expressions, machine learning, or other approaches. Once an attribute in the verifiable credential that matches a form field is identified, the value associated with or defined by that attribute can be used to complete the form field for the web page or web application.

Accordingly, the web application 216 could first validate the verifiable credentials 233 to determine their authenticity. For example, each verifiable credential 233 could have its signature checked using the respective issuer public key 226 of the issuer service 223 that issued the verifiable credential 233. The web application 216 could further confirm whether the issuer of each verifiable credential 233 is included among the trusted issuers 219 of the web application 216. If verifiable credential 233 is valid and/or trusted, then the web application 216 could analyze each verifiable credential to determine the data included. For example, if a verifiable credential 233 included a name, then fields for the first, middle, or last name of the form on the web page could be completed using the name within the verifiable credential 233. Likewise, if a verifiable credential 233 included an address, then an address field of the form for the web page could be completed using the address within the verifiable credential 233.

In some instances, a single verifiable credential 233 may lack sufficient information for each and every field of the form for the webpage. These situations can be handled using a variety of approaches. For example, if only a single verifiable credential 233 is provided to the web application 216, then the web application 216 could fill out the subset of fields that are possible to complete using the information provided by the verifiable credential 233. As another example, if multiple verifiable credentials 233 are provided to the web application 216, then the web application 216 could complete the form or input data into the fields using the set of verifiable credentials 233. For example, if a first verifiable credential 233 contained a name and a second verifiable credential 233 contained an address, the name from the first verifiable credential 233 could be used to complete fields related to the name of the user and the address from the second verifiable credential 233 could be used to complete fields related to the address of the user.

In any of the above instances, once the web-application 216 has acquired the desired information from the verifiable credential(s) 233 returned by the wallet application 246, the web-application 216 could update the webpage to reflect the information. For example, the web-application 216 could use an asynchronous JavaScript connection to provide the information from the verifiable credentials 233 to the browser 243 for display. As another example, the web-application 216 could refresh and resend the web page to the browser 243.

Subsequently, at block 433, the browser 243 can update the web page displayed to the user to include the values from the verifiable credential(s) 233 shared by the wallet application 246 to the web application 216. In some implementations, the values could be editable to allow the user to make any corrections of errors. In other implementations, however, the values may not be editable in order to prevent users from tampering with the data derived from the verifiable credential(s) 233. The user would then have the option to review the update web page and submit it if desired.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
establish a decentralized identifier communication (DIDComm) protocol connection with a wallet application;
send a request to the wallet application for a verifiable credential;
receive, from the wallet application, the verifiable credential;
verify that the verifiable credential is valid;
fill at least one field of a web application with the at least one value specified by the verifiable credential; and
update the web application to reflect that the at least one field has been filled with the at least one value.

2. The system of claim 1, wherein the machine-readable instructions further cause the computing device to at least:
include a decentralized identifier (DID) in the request to the wallet application; and
wherein the at least one verifiable credential is issued by an issuer identified by the DID.

3. The system of claim 2, wherein the DID identifies a verifiable credential issuer trusted by a host of the web application.

4. The system of claim 2, wherein the DID identifies a host of the web application.

5. The system of claim 1, wherein the machine-readable instructions that cause the computing device to fill the at least one field with the at least one value specified by the verifiable credential further cause the computing device to at least:
identify an attribute of the verifiable credential, the attribute corresponding to the at least one value; and
determine that the attribute corresponds to the at least one field in the web application.

6. The system of claim 1, wherein the machine-readable instructions that cause the computing device to establish the DIDComm protocol connection with the wallet application further cause the computing device to at least update the web application to show a matrix bar code representing a DIDComm message.

7. The system of claim 1, wherein the machine-readable instructions further cause the computing device to send the update for the web application that reflects the at least one field has been filled with the at least one value to a browser on a client device.

8. A method implemented by a computing device, comprising:
establishing a decentralized identifier communication (DIDComm) protocol connection with a wallet application;
sending a request to the wallet application for a verifiable credential that contains at least one value for at least one field in a web application;
receiving, from the wallet application, the verifiable credential;
verifying that the verifiable credential is valid;
filling the at least one field with the at least one value specified by the verifiable credential; and
updating the web application to reflect that the at least one field has been filled with the at least one value.

9. The method of claim 8, further comprising:
including a decentralized identifier (DID) of a host of the web application in the request to the wallet application; and
wherein the at least one verifiable credential is issued by the host of the web application.

10. The method of claim 8, further comprising:
including a decentralized identifier (DID) of a verifiable credential issuer trusted by the web application in the request to the wallet application; and
wherein the at least one verifiable credential is issued by the verifiable credential issuer trusted by the web application.

11. The method of claim 8, wherein filling the at least one field with the at least one value specified by the verifiable credential further comprises:
identifying an attribute of the verifiable credential, the attribute corresponding to the at least one value; and
determining that the attribute corresponds to the at least one field in the web application.

12. The method of claim 8, wherein establishing the DIDComm protocol connection with the wallet application further comprises updating the web application to show a matrix bar code representing a DIDComm message.

13. The method of claim 8, further comprising sending the update for the web application that reflects the at least one field has been filled with the at least one value to a browser on a client device.

14. The method of claim 13, wherein the field is not editable.

15. A system, comprising:
a computing device comprising a processor and a memory; and
machine-readable instructions stored in the memory that, when executed by the processor, cause the computing device to at least:
establish a decentralized identifier communication (DIDComm) connection with a web application;
receive a request from a host of the web application, the request specifying a decentralized identifier (DID) of an issuer of a verifiable credential;
identify a verifiable credential issued by an issuer associated with the DID; and
return the verifiable credential to the web application.

16. The system of claim 15, wherein the machine-readable instructions, when executed by the processor, further cause the computing device to at least:
show a prompt on a display of the computing device, the prompt requesting a user to grant permission to share the verifiable credential with the web application; and
the verifiable credential is returned to the web application in response to receipt of permission to share the verifiable credential with the web application.

17. The system of claim 15, wherein the machine-readable instructions, when executed by the processor, further cause the computing device to at least receive a web page associated with the web application, the web page comprising a form with a value from the verifiable credential included in a field of the form.

18. The system of claim 17, wherein the field of the form is editable.

19. The system of claim 17, wherein the field of the form is not editable.

20. The system of claim 15, wherein the DID is included in a list of DIDs that identify a set of issuers trusted by the web application.
